(19) United States
(12) Patent Application Publication
(10) Pub. No.: US 2021/0343199 A1
(43) Pub. Date: Nov. 4, 2021

(54) PARTY POSTS

(71) Applicants: Dean R. Beddow, Wadsworth, OH (US); Mary K. Beddow, Wadsworth, OH (US)

(72) Inventors: Dean R. Beddow, Wadsworth, OH (US); Mary K. Beddow, Wadsworth, OH (US)

(21) Appl. No.: 16/578,790

(22) Filed: Sep. 23, 2019

Related U.S. Application Data
(60) Provisional application No. 62/765,964, filed on Sep. 24, 2018.

(51) Int. Cl. G09F 15/00

(52) U.S. Cl. CPC G09F 15/0037; G09F 15/0018

(57) ABSTRACT

The present invention provides a method of securing a pair of signs to a post. The method includes the first step of providing a first and second sign wherein each sign has a pair of holes therein. Next, a securing means is provided, then the first sign is placed flush against a first side of the post while the second sign is placed flush against a second side of the post. Finally, the first and second signs are secured against the post utilizing the securing means being wound through said each pair of holes.

### CROSS-REFERENCE TO RELATED APPLICATIONS

This application claims the benefit of U.S. Provisional Patent Application No. 62/765,964 filed on Sep. 24, 2018, the disclosure of which is incorporated herein by reference.

### FIELD OF THE INVENTION

The present invention is generally directed toward signage affixed to either side of a mailbox post or similar post. More particularly, the present invention is directed toward a pair of signs, wherein one of the pair is attached to one side of a post and the other of the pair is attached to the other side of the post. More specifically, the present invention is directed toward a pair of signs wherein each sign, preferably generally rigid in nature, contains two or more sets of grommet holes punched therein that will allow for the use of cabling to attach the signs to a post.

### BACKGROUND OF THE INVENTION

Display devices for mounting on poles are quite common and well known. For example, they are frequently utilized in automobile service stations, which commonly have at least one vertical pole in a prominent place to display the trade mark of the gasoline being sold. The display signs are generally mounted on the pole, and below the permanent sign displaying the gasoline trade mark. These pole signs are generally of a somewhat temporary character, frequently advertising a current promotion of the dealer. The signs are therefore usually made of cardboard or the like. In spite of the fact that they are often temporary, display signs must be quite securely mounted in order to withstand wind and the elements,

Heretofore, such signs have generally been mounted on poles by means of a bracket assembly mounted on the pole underneath the sign. Such bracket assemblies have the disadvantage that they are expensive and that it is relatively time-consuming to mount them on the pole. If such brackets are left on the pole on a permanent basis, they are unsightly during periods when there is no sign attached to the pole to cover them. With some designs that have previously been used, the aforementioned brackets are not even covered when a sign is in place, which also detracts from the overall appearance.

One will realize that poles and posts may be found in nearly any environment. There are support poles in buildings, utility poles lining streets, poles on ski mountains for supporting ski lifts, and mailbox posts in nearly every front yard around the world. One important point that the shear multiplicity of poles raises is that, to date, a tremendous amount of unique advertising space has been left underutilized. Thus far, advertising on poles or posts has been limited substantially to the posting of sheets of paper and the like with tape or tacks. But, sheets of paper posted in this way are liable to be easily ripped off or get destroyed. They also have no protection against the weather elements like rain and snow.

Therefore, there is a need in the art for a means of advertising on poles/posts that provides the ability to advertise on poles/posts of different shapes, dimensions and materials while allowing for long-term use without being easily blown away, blown over, or easily destroyed.

### SUMMARY OF TRE INVENTION

In a first embodiment, the present invention provides a method of securing a pair of signs to a post comprising providing a first and second sign wherein each sign has a pair of holes therein; providing a securing means; positioning said first sign flush against a first side of a post; positioning said second sign flush against a second side of the post; and securing said first and second signs against the post utilizing the securing means being wound through said each pair of holes in each sign.

In a second embodiment, the present invention provides a method of securing a pair of signs to a post as in any embodiment above, further comprising the step of providing a second securing means and wherein said first and second sign each include a second pair of holes therein and wherein said second securing means is wound through said second pair of holes in each sign to further secure said signs against the post.

In a third embodiment, the present invention provides a method of securing a pair of signs to a post as in any embodiment above, wherein said securing means and said second securing means are selected from the group consisting of cable ties, rope, or bungee cord.

In a fourth embodiment, the present invention provides a kit comprising a first sign including a pair of hole therein; a second sign including a pair of hole therein; and a securing means.

In a fifth embodiment, the present invention provides a kit as in any embodiment above, wherein said first and second sign each include a second pair of holes wherein said second pair of holes are located in a position below said pair of holes.

In a sixth embodiment, the present invention provides a kit as in any embodiment above, further including a second securing means.

In a seventh embodiment, the present invention provides a kit as in any embodiment above, wherein said securing means and said second securing means are selected from the group consisting of cable ties, rope, or bungee cord.

In an eighth embodiment, the present invention provides a decorative sign for attachment to a post or pole, the sign including a body, a first pair of holes located in the middle of said body, and a second pair of holes located in the middle of said body below said first pair of holes

### BRIEF DESCRIPTION OF THE DRAWINGS

For a more complete understanding of the features and advantages of the present invention, reference is now made to the detailed description of the invention along with the accompanying figures in which:

FIG. 1 is a plan view of one sign of one embodiment of the present invention;

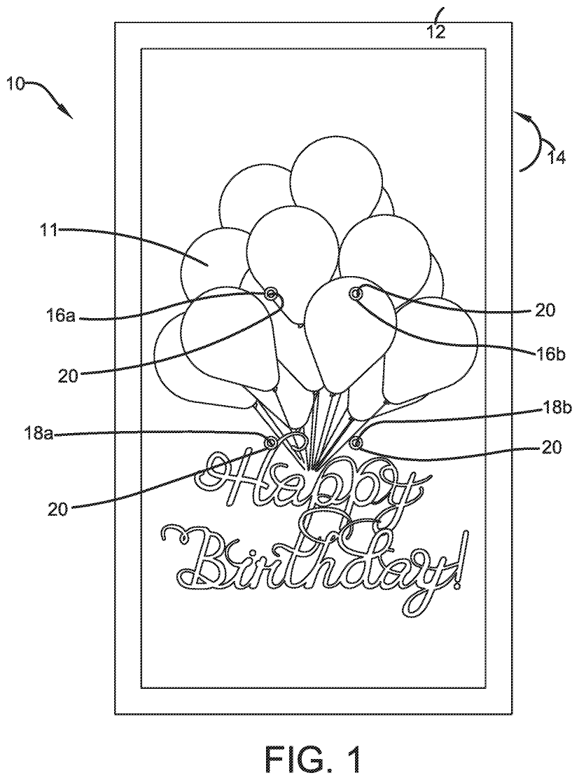

FIG. 2 is a perspective view of one embodiment of the present invention shown deployed around a mailbox post; and

FIG. 3 is another perspective view of one embodiment of the present invention shown deployed around a mailbox post.

### DETAILED DESCRIPTION OF ILLUSTRATIVE EMBODIMENTS

The present invention relates to a pair of decorative signs typically installed on each side of a single post or pole, such as a mailbox post. In one or more embodiments, the pair of signs can contain advertising, announcements, demonstrations of support for an athletic team, individual, group, church, political party, organization, or the like. In one embodiment, both signs can contain identical indicia, or in other embodiments, the pair of signs can contain different indicia.

In one or more embodiments of the present invention, the number 10 generally, indicates one sign of the pair of decorative signs of the present invention. Sign 10 is generally in the shape of a rectangle, but other shapes can be utilized. Sign 10 has a front side 12 and a back side 14. Front side 12 will contain indicia 11 and back side 14 will be blank. Sign 10 will also contain a first pair of holes 16a and 16b as well as a second pair of holes 18a and 18b. First pair of holes 16a and 16b will be located generally in the middle of sign 10 at a location above the second pair of holes 18a and 18b, also located generally in the middle of sign 10. Furthermore, each hole 16a, 16b, 18a, and 18b will be protected with a grommet 20.

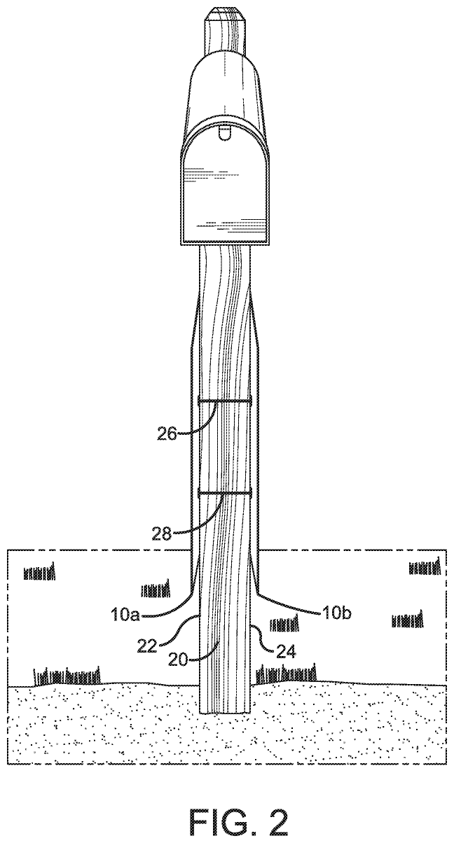

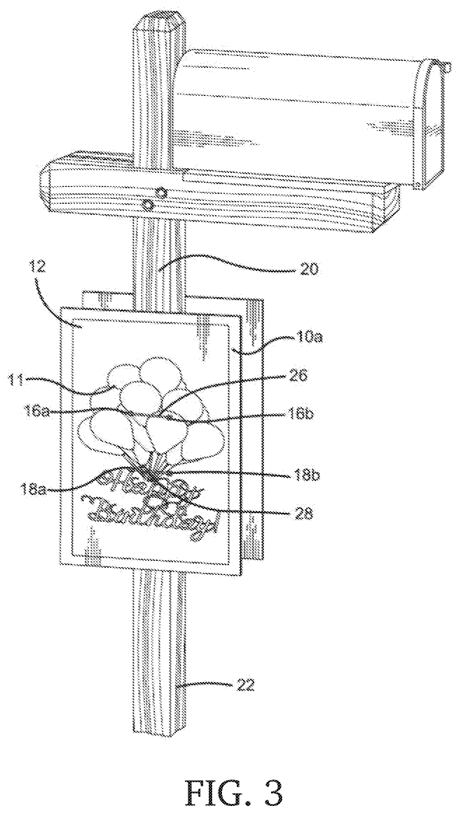

FIGS. 2 and 3 show how a pair of signs 10a and 10b are to be installed on a post or pole, such as mailbox post 20. Sign 10a is placed on a first side 22 of post 20 and sign 10b is placed on a second side 24 of post 20. The pair of signs 10a and 10b are therefore positioned in a back to back orientation with the post 20 placed in between. To secure signs 10a and 10b to post 20, a first securement means 26 will be run through the first pair of holes 16a and 16b on sign 10a, then the securement means 26 will be wrapped around post 20, then through the first pair of holes 16a and 16b on sign 101), back around post 20, and then securement means 26 will be secured with itself in a position adjacent the first pair of holes 16a and 16b on sign 10a. In one embodiment of the present invention, a second securement means 28 will then be run through the second pair of holes 18a and 18b on sign 10a, then second securement means 28 will be wrapped around post 20, then through the second pair of holes 18a and 18b on sign 101), back around post 20, and then securement means 28 will be secured with itself in a position adjacent the second pair of holes 18a and 18b on sign 10b.

By securing signs 10a and 10b in this manner, the indicia on signs 10a and 10b can be seen on both sides of post 20. Furthermore, because holes 16a, 16b, 18a, and 18b are located generally in the middle of signs 10a and 10b, signs 10a and 10b will be able to maintain their shape and they will not appear warped around post 20.

In one or more embodiments of the present invention, signs 10a and 10b are made from a rigid material selected from corrugated plastic, corrugated metal, cardboard, and combinations thereof.

In one or more embodiments of the present invention, securement means 26 and securement means 28, if present, are selected from the group consisting of zip ties, bungee cords, rope, and combinations thereof.

In one embodiment of the present invention securement means 26 and securement means 28, if present, are both zip ties such that each zip tie has a flexible tape section with teeth that engage with a pawl in the head to form a ratchet so that as the free end of the tape section is pulled the cable tie tightens and does not come undone.

In one embodiment of the present invention securement means 26 and securement means 28, if present, are both bungee cords such that each bungee cord has a hook on each end that secures with each other to secure the securement means 26 and 28 to itself.

In one embodiment of the present invention securement means 26 and securement means 28, if present, are both ropes such that each piece of rope will be tied in a note with itself to secure the signs 10a and 10b to a post.

In one or more embodiments of the present invention, securement means 26 and securement means 28, if present, each have a length of at least 16 inches, in other embodiment at least 17 inches, and in yet other embodiments at least 18 inches. In one or more embodiments of the present invention, securement means 26 and securement means 28, if present, each have a length of at most 21 inches, in other embodiments at least 20 inches, and in yet other embodiments at least 19 inches, in one or more embodiments of the present invention, securement means 26 and securement means 28, if present, each have a length of between 16 and 21 inches, in other embodiments between 17 and 20 inches, and in yet other embodiments between 18 and 19 inches.

In one or more embodiments of the present invention, signs 10a and 10b each have a thickness of greater than 0.5 millimeters, in other embodiments greater than 1.0 millimeters, and in yet other embodiments greater than 1.5 millimeters. In one or more embodiments of the present invention, signs 10a and 10b each have a thickness of less than 5.0 millimeters, in other embodiments less than 4.0 millimeters, and in yet other embodiments less than 3.0 millimeters. In one or more embodiments of the present invention, signs 10a and 10b each have a thickness of between 0.5 and 5.0 millimeters, in other embodiments between 1.0 and 4.0 millimeters, and in yet other embodiments between 1.5 and 3.0 millimeters.

In one or more embodiments of the present invention, signs 10a and 10b have a horizontal width of greater than 8 inches, in other embodiments greater than 9 inches, and in yet other embodiments greater than 10 inches. In one or more embodiments of the present invention, signs 10a and 10b have a horizontal width of less than 16 inches, in other embodiments less than 15 inches, and in yet other embodiments less than 14 inches. In one or more embodiments of the present invention, signs 10a and 10b have a horizontal width of between 8 and 16 inches, in other embodiment between 9 and 15 inches, and in yet other embodiments between 10 and 14 inches.

In one or more embodiments of the present invention, signs 10a and 10b have a vertical length of greater than 20 inches, in other embodiments greater than 24 inches, and in yet other embodiments greater than 28 inches. In one or more embodiments of the present invention, signs 10a and 10b have a vertical length of less than 40 inches, in other embodiments less than 36 inches, and in yet other embodiments less than 32 inches. In one or more embodiments of the present invention, signs 10a and 10b have a vertical length of between 20 and 40 inches, in other embodiment between 24 and 36 inches, and in yet other embodiments between 28 and 32 inches.

In one or more embodiments of the present invention, first pair of holes 16a and 16h are spaced apart at a distance of at least 3 inches, in other embodiments at least 4 inches, and in yet other embodiments at least 4.5 inches. In one or more embodiments of the present invention, first pair of holes 16a and 16b are spaced apart at a distance of at most 6 inches, in other embodiments at most 5.5 inches, and in yet other embodiments at most 5 inches. In one or more embodiments of the present invention, first pair of holes 16a and 16b are spaced apart at a distance of between 3 and 6 inches, in other embodiments between 4 and 5.5 inches, and in yet other embodiments between 4.5 and 5 inches.

In one or more embodiments of the present invention, second pair of holes 18a and 18b are spaced apart at a distance of at least 3 inches, in other embodiments at least 4 inches, and in yet other embodiments at least 4.5 inches. In one or more embodiments of the present invention, second pair of holes 18a and 18b are spaced apart at a distance of at most 6 inches, in other embodiments at most 5.5 inches, and in yet other embodiments at most 5 inches. In one or more embodiments of the present invention, second pair of holes 18a and 18b are spaced apart at a distance of between 3 and 6 inches, in other embodiments between 4 and 5.5 inches, and in yet other embodiments between 4.5 and 5 inches.

In one or more embodiments of the present invention, first pair of holes 16a and 16b are spaced apart from the second pair of holes 18a and 18b at a distance of at least 3 inches, in other embodiments at least 4 inches, and in yet other embodiments at least 4.5 inches. In one or more embodiments of the present invention, first pair of holes 16a and 16b are spaced apart from the second pair of holes 18a and 18b at a distance of at most 6 inches, in other embodiments at most 5.5 inches, and in yet other embodiments at most 5 inches. In one or more embodiments of the present invention, first pair of holes 16a and 16b are spaced apart from the second pair of holes 18a and 18b at a distance of between 3 and 6 inches, in other embodiments between 4 and 5.5 inches, and in yet other embodiments between 4.5 and 5 inches.

In light of the foregoing, it should be appreciated that the present invention significantly advances the art by providing a decorative sign(s) and method of securing said decorative sign(s) that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow,

What is claimed is:

1. A method of securing a pair of signs to a post comprising:
a. providing a first and second sign wherein each sign has a pair of holes therein;
b. providing a securing means;
c. positioning said first sign flush against a first side of the post;
d. positioning said second sign flush against a second side of the post; and
e. securing said first and second signs against the post utilizing the securing means being wound through said each pair of holes in each sign.

2. The method of claim 1 further comprising the step of providing a second securing means and wherein said first and second sign each include a second pair of holes therein and wherein said second securing means is wound through said second pair of holes in each sign to further secure said signs against the post.

3. The method of claim 2 wherein said securing means and said second securing means are selected from the group consisting of cable ties, rope, or bungee cord.

4. A kit comprising:
a. a first sign including a pair of holes therein;
b. a second sign including a pair of hole therein; and
c. a securing means.

5. The kit of claim 4, wherein said first and second sign each include a second pair of holes wherein said second pair of holes are located in a position below said pair of holes.

6. The kit of claim 5, further including a second securing means.

7. The kit of claim 6, wherein said securing means and said second securing means are selected from the group consisting of cable ties, rope, or bungee cord.

8. A decorative sign for attachment to a post or pole, the sign including a body, a first pair of holes located in the middle of said body, and a second pair of holes located in the middle of said body below said first pair of holes.
